(19) United States
(12) Patent Application Publication
(10) Pub. No.: US 2013/0133540 A1
(43) Pub. Date: May 30, 2013

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM CORPORATION, Tokyo (JP)

(72) Inventor: Shigefumi KANCHIKU, Haibara-gun (JP)

(73) Assignee: FUJIFILM CORPORATION, Tokyo (JP)

(21) Appl. No.: 13/689,119

(22) Filed: Nov. 29, 2012

(30) Foreign Application Priority Data
Nov. 30, 2011 (JP) 2011-261734

(51) Int. Cl. C08F 220/28; B41N 1/14; B41N 3/00

(52) U.S. Cl. CPC C08F 220/28; B41N 3/003; B41N 1/14
USPC 101/453; 101/463.1; 526/279; 264/400

(57) ABSTRACT

A resin composition for laser engraving that comprises (Component A) a resin that has a group selected from the group consisting of groups represented by Formula (I) to Formula (III) and is a plastomer at 20° C.; (Component B) an ethylenically unsaturated compound; and (Component C) a polymerization initiator. In Formula (I) to Formula (III), X, Y, and Z independently denote an alkylene group having 1 to 30 carbons, R¹, R⁴, and R⁷ independently denote a hydrogen atom or a methyl group, R², R³, R⁵, R⁶, R⁸, R⁹, R¹⁰, and R¹¹ independently denote an alkyl group, an alkoxy group, a halogen atom, or a hydroxy group, and a wavy line portion denotes a position of bonding to another structure.

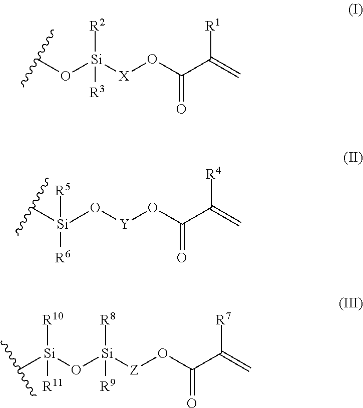

### TECHNICAL FIELD

The present invention relates to a resin composition for laser engraving, a flexographic printing plate precursor for laser engraving and a process for producing the same, and a flexographic printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As a resin composition for laser engraving, those described in Japanese Patent No. 2846954, JP-A-2004-262136 (JP-A denotes a Japanese unexamined patent application publication), or JP-T-2011-510839 (JP-T denotes a published Japanese translation of a PCT application) are known.

### DISCLOSURE OF THE PRESENT INVENTION

### Problems that the Present Invention is to Solve

It is an object of the present invention to provide a resin composition for laser engraving that has excellent stability and can give a flexographic printing plate having excellent rinsing properties, ink transfer properties, and printing durability, a flexographic printing plate precursor and a process for producing same employing the resin composition for laser engraving, and a flexographic printing plate and a process for making same.

### Means for Solving the Problems

The above-mentioned object of the present invention has been attained by solution means <1>, <10> to <12>, <14>, and <15> below. They are described below together with <2> to <9>, <13>, <16>, and <17>, which are preferred embodiments.

<1> A resin composition for laser engraving comprising (Component A) a resin that has a group selected from the group consisting of groups represented by Formula (I) to Formula (III) and is a plastomer at 20° C., (Component B) an ethylenically unsaturated compound, and (Component C) a polymerization initiator,

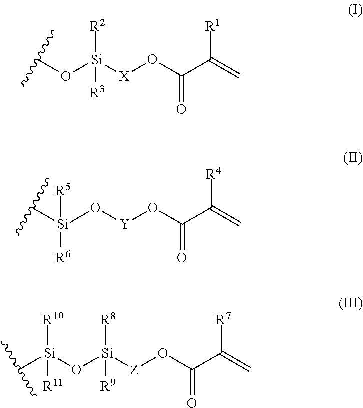

(In Formula (I) to Formula (III) X, Y, and Z independently denote an alkylene group having 1 to 30 carbons, R¹, R⁴, and R⁷ independently denote a hydrogen atom or a methyl group, R², R³, R⁵, R⁶, R⁸, R⁹, R¹⁰, and R¹¹ independently denote an alkyl group, an alkoxy group, a halogen atom, or a hydroxy group, and a wavy line portion denotes a position of bonding to another structure.)
<2> the resin composition for laser engraving according to <1> above, wherein R², R³, R⁵, R⁶, R⁸, and R⁹ above are independently alkyl groups,
<3> the resin composition for laser engraving according to <1> or <2> above, wherein Component A is a resin that has a group represented by Formula (I) or Formula (II) and is a plastomer at 20° C.,
<4> the resin composition for laser engraving according to any one of <1> to <3> above, wherein Component A is a resin that has a group represented by Formula (I) and is a plastomer at 20° C.,
<5> the resin composition for laser engraving according to any one of <1> to <4> above, wherein Component A is a resin that has on at least a main chain terminal a group selected from the group consisting of groups represented by Formula (I) to Formula (III),
<6> the resin composition for laser engraving according to any one of <1> to <5> above, wherein Component A is a straight-chain resin,
<7> the resin composition for laser engraving according to any one of <1> to <6> above, wherein Component B comprises a polyalkylene glycol di(meth)acrylate,
<8> the resin composition for laser engraving according to any one of <1> to <7> above, wherein Component B comprises at least two types of polyalkylene glycol di(meth)acrylates,
<9> the resin composition for laser engraving according to any one of <1> to <8> above, wherein the resin composition further comprises (Component D) a photothermal conversion agent,
<10> a flexographic printing plate precursor for laser engraving, comprising a relief-forming layer comprising the resin composition for laser engraving according to any one of <1> to <9> above,
<11> a flexographic printing plate precursor for laser engraving, comprising a crosslinked relief-forming layer formed by crosslinking by means of light and/or heat a relief-forming layer comprising the resin composition for laser engraving according to any one of <1> to <9> above,
<12> a process for producing a flexographic printing plate precursor for laser engraving, comprising a layer formation step of forming a relief-forming layer comprising the resin composition for laser engraving according to any one of <1> to <9> above and a crosslinking step of crosslinking the relief-forming layer by means of light and/or heat to thus obtain a flexographic printing plate precursor comprising a crosslinked relief-forming layer,
<13> the process for producing a flexographic printing plate precursor for laser engraving according to <12> above, wherein the crosslinking step is a step of crosslinking the relief-forming layer by means of heat to thus obtain a flexographic printing plate precursor comprising a crosslinked relief-forming layer,
<14> a process for making a flexographic printing plate, comprising an engraving step of laser-engraving the crosslinked relief-forming layer made by the process for producing a flexographic printing plate precursor for laser engraving according to <12> or <13> above,
<15> a flexographic printing plate comprising a relief layer made by the process for making a flexographic printing plate according to <14> above,
<16> the flexographic printing plate according to <15> above, wherein the relief layer has a thickness of at least 0.05 mm but no greater than 10 mm, and
<17> the flexographic printing plate according to <15> or <16> above, wherein the relief layer has a Shore A hardness of at least 50° but no greater than 90°.

### MODE FOR CARRYING OUT THE PRESENT INVENTION

The present invention is explained in detail below.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

Furthermore, ‘(Component A) a resin that has a group selected from the group consisting of groups represented by Formula (I) to Formula (III) and is a plastomer at 20° C.’ etc. are simply called ‘Component A’ etc.

### (Resin Composition for Laser Engraving)

The resin composition for laser engraving (hereinafter, also called simply a ‘resin composition’) of the present invention comprises (Component A) a resin that has a group selected from the group consisting of groups represented by Formula (I) to Formula (III) and is a plastomer at 20° C., (Component B) an ethylenically unsaturated compound, and (Component C) a polymerization initiator.

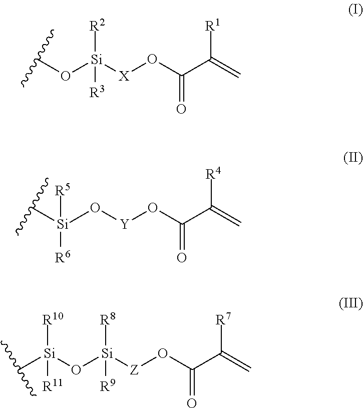

(In Formula (I) to Formula (III), X, Y, and Z independently denote an alkylene group having 1 to 30 carbons, R¹, R⁴, and R⁷ independently denote a hydrogen atom or a methyl group, R², R³, R⁵, R⁶, R⁸, R⁹, R¹⁰, and R¹¹ independently denote an alkyl group, an alkoxy group, a halogen atom, or a hydroxy group, and a wavy line portion denotes a position of bonding to another structure.)

Since the resin that has a group selected from the group consisting of groups represented by Formula (I) to Formula (III) and is a plastomer at 20° C. (Component A) does not have a functional group having cohesiveness such as a urethane, urea, or amide in the vicinity of a polymerizable group, the coating solution stability thereof is good. Furthermore, rinsing properties are improved by a silanol that is generated when there is thermal decomposition due to engraving. Furthermore, unlike a case in which a silicone oil is used, the ink transfer properties do not deteriorate.

The resin composition for laser engraving of the present invention may be applied to a wide range of uses where it is subjected to laser engraving, other than use as a relief-forming layer of a flexographic printing plate precursor, without particular limitations. For example, it may be applied not only to a relief-forming layer of a printing plate precursor where formation of a raised relief is carried out by laser engraving, which is explained in detail below, but also to the formation of various types of printing plates or various types of moldings in which image formation is carried out by laser engraving, such as another material form having asperities or openings formed on the surface such as for example an intaglio printing plate, a stencil printing plate, or a stamp.

Among them, the application thereof to the formation of a relief-forming layer provided on an appropriate support is a preferred embodiment.

In the present specification, with respect to explanation of the flexographic printing plate precursor, a non-crosslinked crosslinkable layer comprising Component A and Component B and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Constituent components of the resin composition for laser engraving are explained below.

(Component A) Resin that has Group Selected from Group Consisting of Groups Represented by Formula (I) to Formula (III) and is Plastomer at 20° C.

The resin composition for laser engraving of the present invention comprises (Component A) a resin that has a group selected from the group consisting of groups represented by Formula (I) to Formula (III) and is a plastomer at 20° C.

In the description below, a resin that has a group represented by Formula (I) and is a plastomer at 20° C. is also called resin A1, a resin that has a group represented by Formula (II) and is a plastomer at 20° C. is also called resin A2, and a resin that has a group represented by Formula (III) and is a plastomer at 20° C. is also called resin A3.

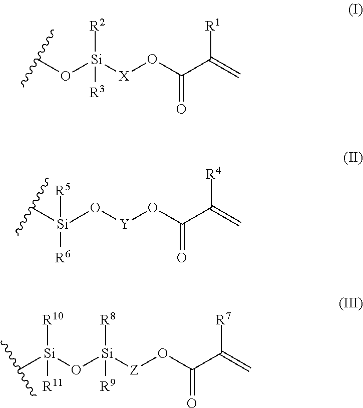

(In Formula (I) to Formula (III), X, Y, and Z independently denote an alkylene group having 1 to 30 carbons, R¹, R⁴, and R⁷ independently denote a hydrogen atom or a methyl group, R², R³, R⁵, R⁶, R⁸, R⁹, R¹⁰, and R¹¹ independently denote an alkyl group, an alkoxy group, a halogen atom, or a hydroxy group, and a wavy line portion denotes a position of bonding to another structure.)

The ‘plastomer’ in the present invention means a polymer having the property of easily undergoing deformation by flowing and being able to be solidified in the deformed shape by cooling, as described in ‘New Polymer Dictionary’ Ed. by the Society of Polymer Science, Japan (Published in 1988, Asakura Publishing Co., Ltd., Japan). The term plastomer is the opposite of an elastomer (having the property, when an external force is applied, of deforming in response to the external force and, when the external force is removed, recovering to the original shape in a short time).

In the present invention, the plastomer means that, when the original dimensions are 100%, it can be deformed up to 200% by means of a small external force at room temperature (20° C.) and will not return to 130% or below even if the external force is removed. More particularly, the plastomer means a polymer with which, based on the tensile permanent strain test of JIS K 6262-1997, an I-shaped specimen can be extended to 2 times the gauge length before pulling in a tensile test at 20° C., and the tensile permanent strain measured after extending the specimen to 2 times the gauge length before pulling, subsequently maintaining the specimen for 5 minutes, removing the external tensile force, and maintaining the specimen for 5 minutes, is 30% or greater.

Meanwhile, in the case of a polymer that cannot be subjected to the measurement described above, a polymer which is deformed even if an external force is not applied and does not return to the original shape, corresponds to a plastomer, and for example, a syrup-like resin, an oil-like resin, and a liquid resin correspond thereto.

Furthermore, the plastomer of the present application has a polymer glass transition temperature (Tg) of less than 20° C. In the case of a polymer having two or more Tgs, all of the Tgs are less than 20° C.

The viscosity at 20° C. of Component A is preferably 0.5 Pa·s to 10 kPa·s, more preferably 10 Pa·s to 10 kPa·s, and yet more preferably 50 Pa·s to 5 kPa·s. When the viscosity is in this range, it is easy to mold the resin composition into a sheet-shaped or cylindrical printing plate precursor, and the process is also easy. In the present invention, due to Component A being a plastomer, when molding a printing plate precursor for laser engraving obtained therefrom into a sheet shape or a cylindrical shape, good thickness precision and dimensional precision can be achieved.

The number-average molecular weight Mn of Component A is preferably 1,000 to 200,000, more preferably 2,000 to 150,000, yet more preferably 3,000 to 100,000, and particularly preferably 5,000 to 100,000. A resin composition produced using Component A having a number-average molecular weight in this range is easy to process; moreover, a precursor that is produced by subsequent crosslinking maintains its strength, and a relief image produced from this precursor is strong and can withstand repeated use. The number-average molecular weight of Component A may be measured using a GPC (gel permeation chromatography) method and determined using a standard polystyrene calibration curve.

Furthermore, the groups represented by Formula (I) to Formula (III) in Component A all have at least an ethylenically unsaturated group. Component A is preferably a resin having on at least a main chain terminal a group selected from the group consisting of groups represented by Formula (I) to Formula (III).

In the present invention, ‘terminal’ denotes the position of the carbon atom positioned endmost in a main chain or a side chain of a resin. For example, a terminal ethylenically unsaturated group denotes a double bond between a carbon atom positioned at a terminal and a carbon atom adjacent to the above carbon atom. Furthermore, needless to say, in for example a star polymer, etc., there is a terminal of each dendrimer chain.

Component A is preferably a straight-chain resin. When Component A is a straight-chain resin, it is particularly preferably a resin having a group selected from the group consisting of groups represented by Formula (I) to Formula (III) at both termini of a main chain.

Furthermore, Component A preferably has at least a group represented by Formula (I) or Formula (II) among the groups represented by Formula (I) to Formula (III), and more preferably has at least a group represented by Formula (I).

### <Resin A1>

Resin A1 is a resin that has a group represented by Formula (I) and is a plastomer at 20° C., and is preferably a resin that has a group represented by Formula (I) obtained by reaction between (a1) a resin having a hydroxy group at a terminal and (b1) a silane coupling agent having an ethylenically or acetylenically unsaturated group, and that is a plastomer at 20° C.

(a1) Resin Having Hydroxy Group at Terminal

Preferred examples of the resin having a hydroxy group at a terminal (a1) include a polycarbonate polyol, a polyurethane resin having a hydroxy group at a terminal, a polybutadiene polyol, a carbinol-modified silicone oil, a phenol-modified silicone oil, an acrylic resin having a hydroxy group at a terminal, and a polyester resin having a hydroxy group at a terminal. Among them, a polycarbonate polyol, a straight-chain polyurethane resin having a hydroxy group at a terminal, and a polybutadiene polyol are preferable, and a polycarbonate polyol and a polybutadienediol are more preferable.

### —Polycarbonate Polyol—

As the resin having a hydroxy group at a terminal (a1), a polycarbonate polyol can be used, and a polycarbonate diol is preferable.

Examples of the polycarbonate polyol include a polymer obtainable by allowing a polyol component to react with a carbonate compound such as a dialkyl carbonate, an alkylene carbonate, or a diaryl carbonate, and modification products thereof.

As the polyol component composed of the polycarbonate polyol, compounds that are generally used in the production of a polycarbonate polyol can be used, and examples thereof include aliphatic diols having 2 to 15 carbon atoms, such as ethylene glycol, diethylene glycol, triethylene glycol, propylene glycol, 1,3-propanediol, 2-methyl-1,3-propanediol, 2,2-diethyl-1,3-propanediol, 1,3-butanediol, 1,4-butanediol, 2-methyl-1,4-butanediol, neopentyl glycol, 1,5-pentanediol, 3-methyl-1,5-pentanediol, 1,6-hexanediol, 1,7-heptanediol, 1,8-octanediol, 2-methyl-1,8-octanediol, 2,7-dimethyl-1,8-octanediol, 1,9-nonanediol, 2-methyl-1,9-nonanediol, 2,8-dimethyl-1,9-nonanediol, and 1,10-decanediol; alicyclic diols such as 1,4-cyclohexanediol, cyclohexanedimethanol, and cyclooctanedimethanol; aromatic diols such as 1,4-bis(β-hydroxyethoxy)benzene; and polyhydric alcohols having three or more hydroxyl groups per molecule, such as trimethylolpropane, trimethylolethane, glycerin, 1,2,6-hexanetriol, pentaerythritol, and diglycerin. In the production of a polycarbonate polyol, such a polyol component may be used alone, or two or more kinds may be used in combination.

Among these, for the production of a polycarbonate polyol, it is preferable to use an aliphatic diol having 5 to 12 carbon atoms and having a methyl group as a side chain, such as 2-methyl-1,4-butanediol, 3-methyl-1,5-pentanediol, 2-methyl-1,8-octanediol, 2,7-dimethyl-1,8-octanediol, 2-methyl-1,9-nonanediol, or 2,8-dimethyl-1,9-nonanediol, as the polyol component. Particularly, it is preferable to use such an aliphatic diol having 5 to 12 carbon atoms and having a methyl group as a side chain at a proportion of 30 mol % or more of the total amount of the polyol components used in the production of the polyester polyol, and more preferably at a proportion of 50 mol % or more of the total amount of polyol components.

Furthermore, examples of the dialkyl carbonate include dimethyl carbonate and diethyl carbonate, and examples of the alkylene carbonate include ethylene carbonate. Examples of the diaryl carbonate include diphenyl carbonate.

Examples of the polyester polycarbonate polyol described above include a polymer obtainable by allowing a polyol component, a polycarboxylic acid component and a carbonate compound to simultaneously react; a polymer obtainable by allowing a polyester polyol and a polycarbonate polyol that have been synthesized in advance to react with a carbonate compound; and a polymer obtainable by allowing a polyester polyol and a polycarbonate polyol that have been synthesized in advance to react with a polyol component and a polycarboxylic acid component.

The polycarbonate polyol is preferably a polycarbonate diol represented by Formula (I) below.

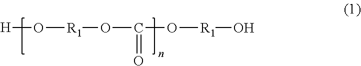

In Formula (I), the R₁s independently denote a straight-chain, branched, and/or cyclic hydrocarbon group having 3 to 50 carbons, which may contain an oxygen atom, etc. (at least one type of atom selected from the group consisting of nitrogen, sulfur, and oxygen) in a carbon skeleton, and R₁ may be a single component or comprise a plurality of components. n is preferably an integer of 1 to 500.

The ‘hydrocarbon group’ in R₁ is a saturated or unsaturated hydrocarbon group, but is preferably a saturated hydrocarbon group.

The ‘carbon skeleton’ in R₁ means a structural part having 3 to 50 carbons forming the hydrocarbon group, and the term ‘which may contain an oxygen atom, etc. in a carbon skeleton’ means a structure in which an oxygen atom, etc. is inserted into a carbon-carbon bond of a main chain or a side chain. Furthermore, it may be a substituent having an oxygen atom, etc., bonded to a carbon atom in a main chain or a side chain.

Examples of the straight-chain hydrocarbon group in R₁ include a hydrocarbon group derived from a straight-chain aliphatic diol having 3 to 50 carbons such as 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,16-hexadecanediol, or 1,20-eicosanediol.

Examples of the branched hydrocarbon group in R₁ include a hydrocarbon group derived from a branched aliphatic diol having 3 to 30 carbons such as 2-methyl-1,3-propanediol, 2-ethyl-1,3-propanediol, neopentyl glycol, 2,2-diethyl-1,3-propanediol, 2-methyl-2-propyl-1,3-propanediol, 2-butyl-2-ethyl-1,3-propanediol, 2,2-dibutyl-1,3-propanediol, 1,2-butanediol, 2-ethyl-1,4-butanediol, 2-isopropyl-1,4-butanediol, 2,3-dimethyl-1,4-butanediol, 2,3-diethyl-1,4-butanediol, 3,3-dimethyl-1,2-butanediol, pinacol, 1,2-pentanediol, 1,3-pentanediol, 2,3-pentanediol, 2-methyl-2,4-pentanediol, 3-methyl-1,5-pentanediol, 2-ethyl-1,5-pentanediol, 3-ethyl-1,5-pentanediol, 2-isopropyl-1,5-pentanediol, 3-isopropyl-1,5-pentanediol, 2,4-dimethyl-1,5-pentanediol, 2,4-diethyl-1,5-pentanediol, 2,3-dimethyl-1,5-pentanediol, 2,2,3-trimethyl-1,3-pentanediol, 1,2-hexanediol, 1,3-hexanediol, 1,4-hexanediol, 2,5-hexanediol, 2-ethyl-1,6-hexanediol, 2-ethyl-1,3-hexanediol, 2-isopropyl-1,6-hexanediol, 2,4-diethyl-1,6-hexanediol, 2,5-dimethyl-2,5-hexanediol, 2-methyl-1,8-octanediol, 2-ethyl-1,8-octanediol, 2,6-dimethyl-1,8-octanediol, 1,2-decanediol, or 8,13-dimethyl-1,20-eicosanediol.

Examples of the cyclic hydrocarbon group in R₁ include a hydrocarbon group derived a cyclic aliphatic diol having 3 to 30 carbons such as 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, m-xylene-α,α′-diol, p-xylene-α,α′-diol, 2,2-bis(4-hydroxycyclohexyl)propane, 2,2-bis(4-hydroxyphenyl)propane, or dimer diol.

A hydrocarbon group derived from a straight-chain aliphatic diol having 3 to 50 carbons is explained as an example: in the present invention, the ‘hydrocarbon group derived from a straight-chain aliphatic diol having 3 to 50 carbons’ means a group which is a partial structure, excluding the diol hydroxy groups, of the straight-chain aliphatic diol having 3 to 50 carbons.

Examples of the hydrocarbon group containing at least one type of atom selected from the group consisting of nitrogen, sulfur, and oxygen in R₁ include a hydrocarbon group derived from diethylene glycol, triethylene glycol, tetraethylene glycol, glycerol, 1,2,6-hexanetriol, trimethylolethane, trimethylolpropane, pentaerythritol, dihydroxyacetone, 1,4:3,6-dianhydroglucitol, diethanolamine, N-methyldiethanolamine, dihydroxyethylacetamide, 2,2′-dithiodiethanol, or 2,5-dihydroxy-1,4-dithiane, and a group represented by Formula (2) below.

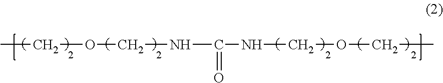

A polycarbonate diol may be produced by for example a conventionally known method as described in JP-B-5-29648 (JP-B denotes a Japanese examined patent application publication), and specifically it may be produced by an ester exchange reaction between a diol and a carbonic acid ester.

In Formula (2) above, from the viewpoint of solvent resistance, R₁ preferably contains at least one ether bond, and from the viewpoint of solvent resistance and durability, R₁ is more preferably a group derived from diethylene glycol (group represented by —(CH₂)₂—O—(CH₂)₂—).

In the present embodiment, with regard to the polycarbonate polyol, one type or two or more types may be used according to the purpose, but it is desirable to use one type of polycarbonate polyol.

The number-average molecular weight of these polycarbonate polyols is preferably in the range of 1,000 to 200,000, more preferably in the range of 1,500 to 10,000, and yet more preferably in the range of 2,000 to 8,000.

### —Polyurethane Resin Having Hydroxy Group at Terminal—

As the resin having a hydroxy group at a terminal (a1), a polyurethane resin having a hydroxy group at a terminal may be used, and it is preferably a polyurethane resin having a hydroxy group at a main chain terminal, and more preferably a straight-chain polyurethane resin having a hydroxy group at a main chain terminal.

The polyurethane resin having a hydroxy group at a terminal is preferably formed by a reaction between at least one type of polyisocyanate and at least one type of polyhydric alcohol component.

The polyhydric alcohol component preferably comprises a polycarbonate polyol, more preferably comprises a polycarbonate diol, and yet more preferably comprises a polycarbonate diol having a constituent repeating unit represented by Formula (4).

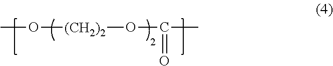

The constituent repeating unit represented by Formula (4) above may comprise a straight-chain and/or branched molecular chain. The polycarbonate diol may be produced by a known method (e.g. JP-B-5-29648) from the corresponding diol.

The polyurethane resin having a hydroxy group at a terminal preferably has at least one type of bond selected from a carbonate bond and an ester bond in the molecule. When Component A has the above bond, the durability of a printing plate toward an ink cleaning agent containing an ester-based solvent or an ink cleaning agent containing a hydrocarbon-based solvent used in printing tends to improve, which is preferable.

A method for producing the polyurethane resin having a hydroxy group at a terminal is not particularly limited, and examples thereof include a method in which a compound that has a carbonate bond or an ester bond, has a plurality of reactive groups such as a hydroxy group, an amino group, an epoxy group, a carboxy group, an acid anhydride group, a ketone group, a hydrazine residue, an isocyanate group, an isothiocyanate group, a cyclic carbonate group, or an alkoxycarbonyl group, and has a molecular weight of on the order of a few thousand is reacted with a compound having a plurality of functional groups that can be bonded to the above-mentioned reactive groups (e.g. a polyisocyanate having a hydroxy group, an amino group, etc.) to thus adjust the molecular weight and convert the molecular terminal into a bonding group.

Examples of the diol compound having a carbonate bond that is used in the production of the polyurethane resin having a hydroxy group at a terminal include aliphatic polycarbonate diols such as 4,6-polyalkylene carbonate diol, 8,9-polyalkylene carbonate diol, and 5,6-polyalkylene carbonate diol. Furthermore, aliphatic polycarbonate diols having an aromatic type molecular structure in the molecule may also be used.

When a terminal hydroxyl group of these compounds is condensation reacted with a diisocyanate compound such as tolylene diisocyanate, diphenylmethane diisocyanate, hexamethylene diisocyanate, isophorone diisocyanate, dicyclohexylmethane diisocyanate, tetramethylxylene diisocyanate, xylene diisocyanate, naphthalene diisocyanate, trimethylhexamethylene diisocyanate, p-phenylene diisocyanate, cyclohexylene diisocyanate, lysine diisocyanate, or triphenylmethane diisocyanate; or a triisocyanate compound such as triphenylmethane triisocyanate, 1-methylbenzene-2,4,6-triisocyanate, naphthalene-1,3,7-triisocyanate, or biphenyl-2,4,4′-triisocyanate, a urethane bond can be introduced.

### —Polybutadiene Polyol—

As the resin having a hydroxy group at a terminal (a1), a polybutadiene polyol may be used.

The polybutadiene polyol is not limited to a polybutadiene polyol having an ethylenically unsaturated group, and may be a hydrogenated polybutadiene polyol. It may be a modified derivative thereof.

The polybutadiene polyol is preferably a polybutadienediol.

The polybutadiene polyol may have both a 1,2-bond unit and a 1,4-bond unit or may have either one thereof. Furthermore, the polybutadiene polyol may have a constituent unit other than a butadiene-derived constituent unit, but is particularly preferably a polybutadienediol having a hydroxy group at both termini of a polymer chain formed from a butadiene-derived constituent unit.

The number-average molecular weight of the polybutadiene polyol is preferably in the range of 1,000 to 200,000, more preferably in the range of 1,000 to 10,000, and yet more preferably in the range of 1,000 to 8,000.

### —Carbinol-Modified Silicone Oil, Phenol-Modified Silicone Oil—

As the resin having a hydroxy group at a terminal (a1), a carbinol-modified silicone oil or a phenol-modified silicone oil may be used.

Examples of a silicone oil forming a main chain include low viscosity to high viscosity polyorganosiloxanes such as a polydimethylsiloxane, a polymethylphenylsiloxane, or a dimethylsiloxane/methylphenylsiloxane copolymer, a cyclic siloxane such as octamethylcyclotetrasiloxane, decamethylcyclopentasiloxane, dodecamethylcyclohexasiloxane, tetramethyltetrahydrogencyclotetrasiloxane, or tetramethyltetraphenylcyclotetrasiloxane, a silicone rubber such as a high degree of polymerization gum-form dimethylpolysiloxane or a gum-form dimethylsiloxane/methylphenylsiloxane copolymer, a cyclic siloxane solution of a silicone rubber, trimethylsiloxysilicic acid, a cyclic siloxane solution of trimethylsiloxysilicic acid, a higher alkoxy-modified silicone such as stearoxysilicone, and a higher fatty acid-modified silicone. Among them, as the carbinol-modified silicone oil or the phenol-modified silicone oil, a resin having a polydimethylsiloxane chain is preferable.

The carbinol-modified silicone oil and the phenol-modified silicone oil may be suitably obtained by modifying the above-mentioned compound having a siloxane bond.

Examples include a carbinol-modified silicone oil, a phenol-modified silicone oil, a silanol-modified silicone oil, and a diol-modified silicone oil. Such a silicone oil having two or more hydroxy groups may be used.

Preferred examples of the carbinol-modified silicone oil and the phenol-modified silicone oil include a silicone oil having both termini carbinol-modified and a silicone oil having both termini phenol-modified. Furthermore, a silicone oil having one terminal modified or a silicone oil having a side chain modified may also be used.

Among them, from the viewpoint of reactivity and handling properties such as odor or irritation, a silicone oil having both termini carbinol-modified is preferable.

As the carbinol-modified silicone oil and the phenol-modified silicone oil, a commercial product may be used, and examples of the silicone oil having both termini carbinol-modified include X-22-160AS and KF-6003 (both manufactured by Shin-Etsu Chemical Co., Ltd.) and BY 16-004 (manufactured by Dow Corning Toray).

### —Acrylic Resin Having Hydroxy Group at Terminal—

As the resin having a hydroxy group at a terminal (a1), an acrylic resin having a hydroxy group at a terminal may be used.

As an acrylic monomer used in synthesis of an acrylic resin having a hydroxy group at a terminal, for example, a (meth)acrylic acid ester, a crotonic acid ester, and a (meth)acrylamide that have a hydroxy group in the molecule are preferable. Specific examples of such a monomer include 2-hydroxyethyl (meth)acrylate, 2-hydroxypropyl (meth)acrylate, and 4-hydroxybutyl (meth)acrylate.

The acrylic resin having a hydroxy group at a terminal may comprise a homopolymer and a copolymer of an acrylic monomer having a hydroxy group, and is preferably a copolymer of an acrylic monomer having a hydroxy group and an acrylic monomer other than the acrylic monomer having a hydroxy group.

Examples of the acrylic monomer other than the acrylic monomer having a hydroxy group, which is copolymerizable with the acrylic monomer having a hydroxy group, include a (meth)acrylic ester, and specific examples of the (meth)acrylic ester include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, 2-ethylhexyl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, the monomethyl ether (meth)acrylate of a copolymer of ethylene glycol and propylene glycol, N,N-dimethylaminoethyl (meth)acrylate, N,N-diethylaminoethyl (meth)acrylate, N,N-dimethylaminopropyl (meth)acrylate, 2-hydroxyethyl (meth)acrylate, 2-hydroxypropyl (meth)acrylate, and 4-hydroxybutyl (meth)acrylate.

Furthermore, a modified acrylic resin formed with a urethane group- or urea group-containing acrylic monomer may preferably be used.

Among them, from the viewpoint of ink transfer properties, an alkyl (meth)acrylate such as lauryl (meth)acrylate and 2-ethylhexyl (meth)acrylate, a (meth)acrylate having ether bond in side chain such as polyethyleneglycol monomethyl ether (meth)acrylate and polypropyleneglycol monomethyl ether (meth)acrylate, and an aliphatic cyclic structure-containing (meth)acrylate such as t-butylcyclohexyl (meth)acrylate are particularly preferable.

### —Polyester Resin Having Hydroxy Group at Terminal—

As the resin having a hydroxy group at a terminal (a1), a polyester resin having a hydroxy group at a terminal may be used. The polyester resin having a hydroxy group at a terminal is preferably a polyester resin having a hydroxy group at a main chain terminal.

The polyester resin having a hydroxy group at a terminal is a resin formed by an esterification reaction or an ester exchange reaction from at least one type of polybasic acid component and at least one type of polyhydric alcohol component.

Specific examples of the polybasic acid component include dibasic acids such as phthalic acid, isophthalic acid, terephthalic acid, tetrahydrophthalic acid, hexahydrophthalic acid, succinic acid, fumaric acid, adipic acid, sebacic acid, and maleic acid; trivlaent or higher-valent polybasic acids such as trimellitic acid, methylcyclohexene tricarboxylic acid, and pyromellitic acid; and acid anhydrides thereof, for example, phthalic anhydride, tetrahydrophthalic anhydride, hexahydrophthalic anhydride, maleic anhydride, trimellitic anhydride, and pyromellitic anhydride.

As the polybasic acid component, one or more dibasic acids selected from the dibasic acids described above, lower alkyl ester compounds of these acids, and acid anhydrides are mainly used. Furthermore, if necessary, a monobasic acid such as benzoic acid, crotonic acid or p-t-butylbenzoic acid; a trivalent or higher-valent polybasic acid such as trimellitic anhydride, methylcyclohexene tricarboxylic acid or pyromellitic anhydride; or the like can be further used in combination.

The polybasic acid component according to the present invention preferably includes at least adipic acid, from the viewpoint of ink transfer properties.

Specific examples of the polyhydric alcohol component include divalent alcohols such as ethylene glycol, diethylene glycol, propylene glycol, dipropylene glycol, 1,4-butanediol, neopentyl glycol, 1,5-pentanediol, 3-methylpentanediol, 1,4-hexanediol, and 1,6-hexanediol; and trivalent or higher-valent polyhydric alcohols such as glycerin, trimethylolethane, trimethylolpropane, and pentaerythritol.

As the polyhydric alcohol component, the divalent alcohols described above are mainly used, and if necessary, trivalent or higher-valent polyhydric alcohols such as glycerin, trimethylolethane, trimethylolpropane, and pentaerythritol can be further used in combination. These polyhydric alcohols can be used individually, or as mixtures of two or more kinds.

The polyhydric alcohol component according to the present invention preferably includes at least 3-methylpentanediol, from the viewpoint of storage stability.

The esterification reaction or transesterification reaction of the polybasic acid component and the polyhydric alcohol component can be carried out by using a usually used method without particular limitations.

(b1) Silane Coupling Agent Having Ethylenically or Acetylenically Unsaturated Group

The silane coupling agent having an ethylenically or acetylenically unsaturated group (b1) is not particularly limited as long as it has an ethylenically or acetylenically unsaturated group and a reactive silyl group and can form Component A by reacting with the resin having a hydroxy group at a terminal (a1).

In the present invention, a functional group in which at least one alkoxy group, hydroxy group, or halogen atom is directly bonded to an Si atom is called a silane coupling group, and a compound having at least one of these silane coupling groups in the molecule is called a silane coupling agent.

The ethylenically or acetylenically unsaturated group of the silane coupling agent is preferably (meth)acryloyl group.

The number of ethylenically or acetylenically unsaturated groups of the silane coupling agent is not particularly limited, but is preferably 1 to 3, more preferably 1 or 2, and particularly preferably 1.

The silyl group of the silane coupling agent is preferably a silyl group represented by Formula (5) below.

—SiR¹R²R³ (5)

(In the Formula, R¹ to R³ independently denote a hydrogen atom, an alkyl group, an alkoxy group, a hydroxy group, or a halogen atom. In addition, at least one of R¹ to R³ is an alkoxy group, a hydroxy group, or a halogen atom.)

Among them, the silyl group of the silane coupling agent is preferably a monoalkoxydialkylsilyl group, a dialkoxymonoalkylsilyl group, or a trialkoxysilyl group, more preferably a monoalkoxydialkylsilyl group or a dialkoxymonoalkylsilyl group, and particularly preferably a monoalkoxydialkylsilyl group. In the above-mentioned embodiment, the storage stability and the printing durability of a printing plate that is obtained are excellent.

From the viewpoint of rinsing properties and printing durability, the numbers of carbons of the alkyl group and the alkoxy group are independently preferably 1 to 30 carbons, more preferably 1 to 8 carbons, yet more preferably 1 to 4 carbons, and particularly preferably 1, that is, a methyl group and a methoxy group.

Furthermore, resin A1 preferably has a group represented by Formula (I) below.

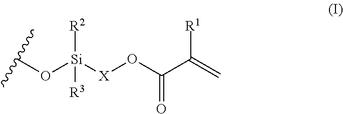

(In Formula (I), X denotes an alkylene group having 1 to 30 carbons, R¹ denotes a hydrogen atom or a methyl group, R² and R³ independently denote an alkyl group, an alkoxy group, a halogen atom, or a hydroxy group, and the wavy line portion denotes a position of bonding to another structure.)

X in Formula (I) is preferably a straight-chain alkylene group having 2 to 20 carbons, more preferably a straight-chain alkylene group having 3 to 10 carbons, and particularly preferably a 1,3-propylene group.

R¹ in Formula (I) is preferably a methyl group.

R² and R³ in Formula (I) are independently preferably an alkyl group or an alkoxy group, and more preferably an alkyl group. R² and R³ are yet more preferably both alkyl groups.

Moreover, the number of carbons of the alkyl group or the alkoxy group in R² and R³ is preferably 1 to 8, more preferably 1 to 4, and particularly preferably 1.

The silane coupling agent having an ethylenically or acetylenically unsaturated group (b1) is preferably a compound represented by Formula (I′).

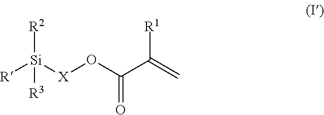

(In the Formula, X denotes an alkylene group having 1 to 30 carbons, R¹ denotes a hydrogen atom or a methyl group, R² and R³ independently denote an alkyl group, an alkoxy group, a halogen atom, or a hydroxy group, and R′ denotes an alkoxy group, a halogen atom, or a hydroxy group.)

X and R¹ to R³ in Formula (I′) have the same meanings as those of X and R¹ to R³ in Formula (I), and preferred embodiments are also the same.

From the viewpoint of printing durability of a printing plate that is obtained and storage stability, R′ in Formula (I′) is preferably an alkoxy group, more preferably an alkoxy group having 1 to 8 carbons, yet more preferably an alkoxy group having 1 to 4 carbons, and particularly preferably a methoxy group.

In the production of resin A1, with regard to each of the resin having a hydroxy group at a terminal (a1) and the silane coupling agent having an ethylenically or acetylenically unsaturated group (b1), one type thereof may be used on its own or two or more types may be used in combination.

The ratio of the resin having a hydroxy group at a terminal (a1) and the silane coupling agent having an ethylenically or acetylenically unsaturated group (b1) used is not particularly limited, but it is preferable to use an amount of silane coupling agent having an ethylenically or acetylenically unsaturated group (b1) that is sufficient to react with the hydroxy group at the terminal, and it is more preferable that the silyl group of the silane coupling agent having an ethylenically or acetylenically unsaturated group (b1) is 1 to 1.5 moles relative to 1 mole of the hydroxy group of the resin having a hydroxy group at a terminal (a1).

### <Resin A2>

Resin A2 is a resin that has a group represented by Formula (II) and is a plastomer at 20° C. and is preferably a resin that has a group represented by Formula (II) obtained by a reaction between (a2) a resin having an alkoxysilyl group and/or a silanol group at a terminal and (b2) an ethylenically or acetylenically unsaturated compound having a hydroxy group and that is a plastomer at 20° C.

(a2) Resin Having Alkoxysilyl Group and/or Silanol Group at Terminal

Preferred examples of the resin having an alkoxysilyl group and/or a silanol group at a terminal (a2) include a silicone resin, a polyurethane resin, a polybutadiene resin, an acrylic resin, and a polyester resin that have an alkoxysilyl group and/or a silanol group at a terminal. Among them, a silicone resin and a polybutadiene resin that have an alkoxysilyl group and/or a silanol group at a terminal are more preferable, and a polybutadiene resin having an alkoxysilyl group and/or a silanol group at a terminal is yet more preferable.

A process for producing the silicone resin is not particularly limited, and it may be produced by a known method.

Furthermore, a process for producing the resin having an alkoxysilyl group and/or a silanol group at a terminal other than the silicone resin is not particularly limited, but it may be suitably produced by a reaction between the above-mentioned resin having a hydroxy group at a terminal and an isocyanate compound having an alkoxysilyl group and/or a silanol group at a terminal.

As the resin having a hydroxy group at a terminal, those described above may suitably be used.

Examples of the isocyanate compound having an alkoxysilyl group and/or a silanol group at a terminal include a compound in which an alkoxysilyl group and/or a silanol group and an isocyanato group are linked via an alkylene group, for example, KBE-9007 (Shin-Etsu Chemical Co., Ltd.), etc.

(b2) Ethylenically or Acetylenically Unsaturated Compound Having Hydroxy Group

The ethylenically or acetylenically unsaturated compound having a hydroxy group (b2) is not particularly limited as long as it has an ethylenically or acetylenically unsaturated group and a hydroxy group and can form Component A by reacting with the resin having an alkoxysilyl group and/or a silanol group at a terminal (a2).

The ethylenically or acetylenically unsaturated group of the ethylenically or acetylenically unsaturated compound having a hydroxy group (b2) has the same meaning as that of the ethylenically or acetylenically unsaturated group in the silane coupling agent having an ethylenically or acetylenically unsaturated group (b1) described above, and preferred embodiments are also the same.

The number of ethylenically or acetylenically unsaturated groups of the ethylenically or acetylenically unsaturated compound having a hydroxy group (b2) is not particularly limited, but is preferably 1 to 3, more preferably 1 or 2, and particularly preferably 1.

Furthermore, the number of hydroxy groups of the ethylenically or acetylenically unsaturated compound having a hydroxy group (b2) is not particularly limited, but is preferably 1 to 3, more preferably 1 or 2, and particularly preferably 1.

The ethylenically or acetylenically unsaturated compound having a hydroxy group (b2) is preferably a compound in which an ethylenically or acetylenically unsaturated group and a hydroxy group are linked via an alkylene group, and is more preferably a compound in which one ethylenically or acetylenically unsaturated group and one hydroxy group are linked via an alkylene group.

The alkylene group may have a straight-chain, branched, or cyclic structure but is preferably a straight-chain alkylene group. Furthermore, the number of carbons of the alkylene group is preferably 1 to 30, more preferably 2 to 20, and yet more preferably 2 to 10.

Moreover, resin A2 preferably has a group represented by Formula (II) below.

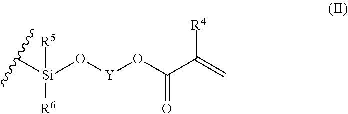

(In Formula (II), Y denotes an alkylene group having 1 to 30 carbons, R⁴ denotes a hydrogen atom or a methyl group, R⁵ and R⁶ independently denote an alkyl group, an alkoxy group, a halogen atom, or a hydroxy group, and the wavy line portion denotes a position of bonding to another structure.)

Y in Formula (II) is preferably an alkylene group having 2 to 30 carbons, more preferably a straight-chain alkylene group having 2 to 20 carbons, yet more preferably a straight-chain alkylene group having 2 to 10 carbons, and particularly preferably an alkylene group having 2 to 4 carbons.

R⁴ in Formula (II) is preferably a methyl group.

R⁵ and R⁶ in Formula (II) are independently preferably an alkyl group or an alkoxy group, and more preferably an alkyl group. Furthermore, it is yet more preferable that both R⁵ and R⁶ are alkyl groups.

Moreover, the number of carbons of the alkyl group or alkoxy group denoted by R⁵ and R⁶ is preferably 1 to 8, more preferably 1 to 4, and particularly preferably 1.

The silane coupling agent having a hydroxy group (b2) is preferably a compound represented by Formula (II′).

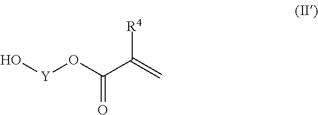

(In the Formula, Y denotes an alkylene group having 1 to 30 carbons and R⁴ denotes a hydrogen atom or a methyl group.)

Y and R⁴ in Formula (II′) have the same meanings as those of Y and R⁴ in Formula (II), and preferred embodiments are also the same.

In the production of resin A2, with regard to each of the resin having an alkoxysilyl group and/or a silanol group at a terminal (a2) and the ethylenically or acetylenically unsaturated compound having a hydroxy group (b2), one type may be used on its own or two or more types may be used in combination.

The ratio of the resin having an alkoxysilyl group and/or a silanol group at a terminal (a2) and the ethylenically or acetylenically unsaturated compound having a hydroxy group (b2) used is not particularly limited, but it is preferable to use an amount of ethylenically or acetylenically unsaturated compound having a hydroxy group (b2) that is sufficient to react with the alkoxysilyl group and/or silanol group at a terminal, and it is more preferable that the hydroxy group of the ethylenically or acetylenically unsaturated compound having a hydroxy group (b2) is 1 to 4.5 moles relative to 1 mole of the alkoxysilyl group and silanol group of the resin having an alkoxysilyl group and/or a silanol group at a terminal (a2).

### <Resin A3>

Resin A3 is a resin that has a group represented by Formula (III) and is a plastomer at 20° C., and is preferably a resin that has an ethylenically or acetylenically unsaturated group obtained by a reaction between the resin having an alkoxysilyl group and/or a silanol group at a terminal (a2) and the silane coupling agent having an ethylenically or acetylenically unsaturated group (b1) and that is a plastomer at 20° C.

The resin having an alkoxysilyl group and/or a silanol group at terminal (a2) has the same meaning as that described for resin A2, and preferred embodiments are also the same.

Furthermore, the silane coupling agent having an ethylenically or acetylenically unsaturated group (b1) has the same meaning as that described for resin A1, and preferred embodiments are also the same.

Moreover, resin A3 preferably has a group represented by Formula (III) below.

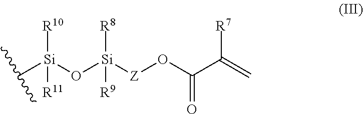

(In Formula (III), Z denotes an alkylene group having 1 to 30 carbons, R⁷ denotes a hydrogen atom or a methyl group, R⁸ to R¹¹ independently denote an alkyl group, an alkoxy group, a halogen atom, or a hydroxy group, and the wavy line portion denotes a position of bonding to another structure.)

Z in Formula (III) is preferably an alkylene group having 1 to 30 carbons, more preferably a straight-chain alkylene group having 2 to 20 carbons, yet more preferably a straight-chain alkylene group having 3 to 10 carbons, and particularly preferably 1,3-propylene group.

R⁷ in Formula (III) is preferably a methyl group.

R⁸ to R¹¹ in Formula (III) are independently preferably an alkyl group or an alkoxy group, and more preferably an alkyl group. Furthermore, it is yet more preferable that all of R⁸ to R¹¹ are alkyl groups.

Furthermore, the number of carbons of the alkyl group or alkoxy group in R⁸ to R¹¹ is preferably 1 to 8, more preferably 1 to 4, and particularly preferably 1.

Among them, from the viewpoint of ink transfer properties, with regard to Component A, the main chain is preferably not a silicone chain, but is more preferably a polyolefin resin, a polyurethane resin, or a polycarbonate resin, yet more preferably a polybutadiene resin or a polycarbonate resin, and particularly preferably a polybutadiene resin.

Furthermore, from the viewpoint of stability, ink transfer properties, and printing durability, it is preferably resin A1 or resin A2, and more preferably resin A1.

With regard to Component A in the resin composition of the present invention, only one type thereof may be used or two or more types thereof may be used in combination.

The content of Component A in the resin composition is preferably 5 to 90 wt % relative to the total solids content, more preferably 15 to 85 wt %, and yet more preferably 30 to 80 wt %. It is preferable for the content of Component A to be in the above-mentioned range since the rinsing properties for engraving residue are excellent and a flexible relief layer is obtained.

The resin composition for laser engraving of the present invention may comprise a binder polymer (resin component) other than Component A. The examples of the binder polymer other than Component A include the non-elastomers described in JP-A-2011-136455, and the unsaturated group-containing polymers described in JP-A-2010-208326.

The resin composition for laser engraving of the present invention preferably comprises Component A as a main component of the binder polymers, and if the resin composition comprises other binder polymers, the content of Component A relative to the total weight of the binder polymers is preferably 60 wt % or greater, more preferably 70 wt % or greater, and yet more preferably 80 wt % or greater. Meanwhile, the upper limit of the content of Component A is not particularly limited, but if the resin composition comprises other binder polymers, the upper limit thereof is preferably 99 wt % or less, more preferably 97 wt % or less, and yet more preferably 95 wt % or less.

### (Component B) Ethylenically Unsaturated Compound

The relief-forming layer in the flexographic printing plate precursor for laser engraving of the present invention contains (Component B) an ethylenically unsaturated compound (also called a “monomer”).

Furthermore, the ethylenically unsaturated compound that can be used in the present invention preferably has a molecular weight (or weight average molecular weight) of less than 5,000.

The ethylenically unsaturated compound may arbitrarily be selected from compounds having at least one ethylenically unsaturated group. The ethylenically unsaturated compound may be used only one type or may be used two or more types in combination.

These compound groups are widely known in the present industrial field, and, in the present invention, these may be used without particular limitation. These have chemical forms such as a monomer, a prepolymer, that is, a dimer, a trimer and an oligomer, or copolymers of monomers, and mixtures thereof.

Component B is preferably a two or more functional ethylenically unsaturated compound (a polyfunctional ethylenically unsaturated compound).

Hereinafter, monofunctional monomers having one ethylenically unsaturated group, and polyfunctional monomers having two or more ethylenically unsaturated groups are explained.

In the resin composition of the present invention, polyfunctional monomers are preferably used in order to form a crosslinked structure in the film. The polyfunctional ethylenically unsaturated compound has preferably a molecular weight of 200 to 2,000.

Examples of the monofunctional monomers include esters of an unsaturated carboxylic acid (such as acrylic acid, methacrylic acid, itaconic acid, crotonic acid, isocrotonic acid or maleic acid) with a monovalent alcohol compound, amides of an unsaturated carboxylic acid with a monovalent amine compound, etc. Examples of the polyfunctional monomers include esters of an unsaturated carboxylic acid (such as acrylic acid, methacrylic acid, itaconic acid, crotonic acid, isocrotonic acid or maleic acid) with a polyvalent alcohol compound, amides of an unsaturated carboxylic acid with a polyvalent amine compound, etc.

Further, addition products of an unsaturated carboxylic acid ester or amide having a nucleophilic substituent such as a hydroxy group, an amino group or a mercapto group with a monofunctional or polyfunctional isocyanate compound or an epoxy compound, dehydrating condensation products with a monofunctional or polyfunctional carboxylic acid, etc. are preferably used.

Moreover, addition reaction products of unsaturated carboxylic acid esters or amides having an electrophilic substituent such as an isocyanato group or an epoxy group with monofunctional or polyfunctional alcohols, amines, or thiols, and substitution reaction products of unsaturated carboxylic acid esters or amides having a leaving group such as a halogen group or a tosyloxy group with monofunctional or polyfunctional alcohols, amines, or thiols are also used preferably.

Among them, the monofunctional monomer is preferably an oligomer having an ethylenically unsaturated group, and is particularly preferably methoxypolyethyleneglycol methacrylate.

As the polyfunctional ethylenically unsaturated compound, a compound having 2 to 20 terminal ethylenically unsaturated groups is preferable.

Examples of compounds from which the ethylenically unsaturated group in the polyfunctional monomer is derived include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group or an amino group with polyfunctional isocyanates or epoxies, and dehydrating condensation reaction products with a polyfunctional carboxylic acid, etc. are also used preferably. Moreover, addition reaction products of unsaturated carboxylic acid esters or amides having an electrophilic substituent such as an isocyanato group or an epoxy group with monofunctional or polyfunctional alcohols or amines, and substitution reaction products of unsaturated carboxylic acid esters or amides having a leaving group such as a halogen group or a tosyloxy group with monofunctional or polyfunctional alcohols or amines are also favorable. Moreover, as another example, the use of compounds obtained by replacing the unsaturated carboxylic acid with a vinyl compound, an allyl compound, an unsaturated phosphonic acid, styrene or the like is also possible.

The polyfunctional monomer described above is preferably an acrylate compound, a methacrylate compound, a vinyl compound, or an aryl compound, and is particularly preferably an acrylate compound or a methacrylate compound.

Specific examples of ester monomers comprising an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane. Among them, trimethylolpropane trimethacrylate is particularly preferable.

As examples of other esters, aliphatic alcohol-based esters described in JP-B-46-27926, JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The ester monomers may be used as a mixture.

Furthermore, specific examples of amide monomers including an amide of an aliphatic polyamine compound and an unsaturated carboxylic acid include N,N′-methylenebisacrylamide, N,N′-methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (I) below is added to a polyisocyanate compound having two or more isocyanate groups per molecule described in JP-B-48-41708.

CH₂═C(R)COOCH₂CH(R′)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure or a sulfide structure in the molecule described in JP-A-63-277653, JP-A-63-260909, and JP-A-1-105238, a photosensitive resin composition having very good photosensitive speed can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Among these, Component B preferably includes a polyalkylene glycol di(meth)acrylate, more preferably includes polyethylene glycol di(meth)acrylate, polypropylene glycol di(meth)acrylate, and/or polyethylene glycol polypropylene glycol di(meth)acrylate, and particularly preferably includes polyethylene glycol di(meth)acrylate.

The content of Component B contained in the resin composition of the present invention is preferably 1 to 90 wt %, more preferably 10 to 80 wt %, yet more preferably 20 to 75 wt %, and particularly preferably 30 to 70 wt %. When the content is in the range described above, the relief-forming layer formed from the resin composition for laser engraving has excellent print durability.

### (Component C) Polymerization Initiator

The resin composition for laser engraving of the present invention comprises (Component C) a polymerization initiator.

With regard to the polymerization initiator, one known to a person skilled in the art may be used without any limitations. Radical polymerization initiators, which are preferred polymerization initiators, are explained in detail below, but the present invention should not be construed as being limited to these descriptions.

In the present invention, as (Component C) the polymerization initiator, a radical polymerization initiator is preferable.

The polymerization initiator may be a photopolymerization initiator or a thermopolymerization initiator, and is preferably a thermopolymerization initiator.

In the present invention, preferable polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the flexographic printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds preferably include the following compounds.

### (c) Organic Peroxide

Preferred examples of the organic peroxide (c) as a polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate, t-butylperoxybenzoate, t-butylperoxy-3-methylbenzoate, t-butylperoxylaurate, t-butylperoxypivalate, t-butylperoxy-2-ethylhexanoate, t-butylperoxy-3,5,5-trimethylhexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, and t-butylperoxy-2-ethylhexylmonocarbonate.

### (l) Azo Compounds

Preferable (l) azo compounds as a polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

In the present invention, the organic peroxide (c) is particularly preferable as the polymerization initiator in the present invention from the viewpoint of crosslinking properties of the film (relief-forming layer) and improving the engraving sensitivity.

From the viewpoint of the engraving sensitivity, an embodiment obtained by combining (c) an organic peroxide, Component B and a photothermal conversion agent described below is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It will be described in detail in the explanation of photothermal converting agent, the effect thereof is remarkable when carbon black is used as the photothermal converting agent. It is considered that the heat generated from the carbon black is also transmitted to (c) an organic peroxide and, as the result, heat is generated not only from the carbon black but also from the organic peroxide, and that the generation of heat energy to be used for the decomposition of Component A etc. occurs synergistically.

Component C in the resin composition of the present invention may be used singly or in a combination of two or more compounds.

The content of Component C in the resin composition of the present invention is preferably 0.1 to 5 wt % relative to the total weight of the solids content, more preferably 0.3 to 3 wt %, and particularly preferably 0.5 to 1.5 wt %.

### (Component D) Photothermal Conversion Agent

The resin composition for laser engraving of the present invention preferably further includes a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximun absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

Component D in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 wt %, more preferably 0.05 to 20 wt %, and particularly preferably 0.1 to 10 wt %, relative to the total weight of the resin composition.

### (Component E) Plasticizer

The resin composition for laser engraving of the present invention may comprise a plasticizer. In the present invention, due to Component A being contained, the relief layer obtained has excellent flexibility, and no plasticizer need be added.

A plasticizer has the function of softening a film formed from the resin composition for laser engraving, and it is necessary for it to be compatible with a binder polymer.

Preferred examples of the plasticizer include dioctyl phthalate, didodecyl phthalate, bisbutoxyethyl adipate, a polyethylene glycol, and a polypropylene glycol (monool type or diol type).

Among them, bisbutoxyethyl adipate is particularly preferable.

With regard to Component E in the resin composition of the present invention, one type thereof may be used on its own or two or more types may be used in combination.

From the viewpoint of maintaining flexible film physical properties, the content of the plasticizer in the resin composition for laser engraving of the present invention is preferably no greater than 50 wt % of the entire solids content concentration, more preferably no greater than 30 wt %, yet more preferably no greater than 10 wt %, and particularly preferably none.

### (Component F) Solvent

It is preferably to use (Component F) a solvent when preparing the resin composition for laser engraving of the present invention.

As the solvent, an organic solvent is preferably used.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

The content of the solvent is not particularly limited, and the content necessary for forming a relief-forming layer, etc. may be added. Meanwhile, the solids content of the resin composition means the content except for the solvent in the resin composition.

### <Other Additives>

The resin composition for laser engraving of the present invention may comprise as appropriate various types of known additives as long as the effects of the present invention are not inhibited. Examples include a filler, a wax, a fragrance, an ultraviolet absorbent, a glidant, a lubricant, a process oil, an a metal oxide, an antiozonant, an anti-aging agent, a thermopolymerization inhibitor, and a colorant, and one type thereof may be used on its own or two more types may be used in combination.

As the filler, inorganic particles can be cited.

The inorganic particles preferably have a number-average particle size of at least 0.01 μm but no greater than 10 μm. Furthermore, the inorganic particles are preferably porous particles or nonporous particles.

The porous particles referred to here are defined as particles having fine pores having a pore volume of at least 0.1 mL/g in the particle or particles having fine cavities.

The porous particles preferably have a specific surface area of at least 10 m²/g but no greater than 1,500 m²/g, an average pore diameter of at least 1 nm but no greater than 1,000 nm, a pore volume of at least 0.1 mL/g but no greater than 10 mL/g, and an oil adsorption of at least 10 mL/100 g but no greater than 2,000 mL/100 g. The specific surface area is determined based on the BET equation from the adsorption isotherm of nitrogen at −196° C. Furthermore, measurement of the pore volume and the average pore diameter preferably employs a nitrogen adsorption method. Measurement of the oil adsorption may be suitably carried out in accordance with JIS-K5101.

The number-average particle size of the porous particles is preferably at least 0.01 μm but no greater than 10 μm, more preferably at least 0.5 μm but no greater than 8 μm, and yet more preferably at least 1 μm but no greater than 5 μm.

The shape of the porous particles is not particularly limited, and spherical, flat-shaped, needle-shaped, or amorphous particles, or particles having projections on the surface, etc. may be used.

Furthermore, particles having a cavity in the interior, spherical granules having a uniform pore diameter such as a silica sponge, etc. may be used. Examples thereof are not particularly limited but include porous silica, mesoporous silica, a silica-zirconia porous gel, porous alumina, and a porous glass. Furthermore, as for a layered clay compound, pore diameter cannot be defined for those having a cavity of a few nm to a few hundred nm between layers, and in the present embodiment the distance between cavities present between layers is defined as the pore diameter.

Moreover, particles obtained by subjecting the surface of porous particles to a surface modifying treatment by covering with a silane coupling agent, a titanium coupling agent, or another organic compound so as to make the surface hydrophilic or hydrophobic may also be used. With regard to these porous particles, one type or two or more types may be selected.

The nonporous particles are defined as particles having a pore volume of less than 0.1 mL/g. The number-average particle size of the nonporous particles is the number-average particle size for primary particles as the target, and is preferably at least 10 nm but no greater than 500 nm, and more preferably at least 10 nm but no greater than 100 nm.

The amount of filler added is not particularly limited, but is preferably 1 to 100 parts by weight relative to 100 parts by weight of Component A.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light or heat.

The flexographic printing plate precursor for laser engraving of the present invention is a flexographic printing plate precursor having a crosslinkable relief-forming layer cured by heat.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking can be performed by light and/or heat, and the crosslinking by heat is preferable. Moreover, the crosslinking is not particularly limited only if it is a reaction that cures the resin composition, and is a general idea that includes the crosslinked structure by the reaction of Component A with each other, and the reaction of Component A with other Component. When a polymerizable compound is used, the crosslinking includes a crosslinking by polymerization of polymerizable compounds.

The ‘flexographic printing plate’ is made by laser engraving the flexographic printing plate precursor having the crosslinked relief-forming layer.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) flexographic printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention, and is preferably crosslinkable by heat.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### <Process for Producing Flexographic Printing Plate Precursor for Laser Engraving>

The process for producing a flexographic printing plate precursor for laser engraving is not particularly limited, and examples thereof include a method in which a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer, and more preferably a production process comprising a layer formation step of forming a relief-forming layer from the resin composition for laser engraving of the present invention and a crosslinking step of crosslinking the relief-forming layer by means of heat to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove solvent.

The resin composition for laser engraving may be produced by, for example, dissolving or dispersing Components A and B, and optional components J in an appropriate solvent, and then dissolving or dispersing Component C.

The thickness of the (crosslinked) relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is preferably a production process comprising a crosslinking step of crosslinking the relief-forming layer by means of heat to thus obtain a flexographic printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need to be irradiated with light, but when the support is a transparent film through which actinic radiation passes, it is preferable to further irradiate from the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises thermal polymerization initiator (the photopolymerization initiator can also be a thermal polymerization initiator.), the relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

### (Flexographic Printing Plate and Process for Making Same)

The process for making a flexographic printing plate of the present invention preferably comprises a layer formation step of forming a relief-forming layer from the resin composition for laser engraving of the present invention, a crosslinking step of crosslinking the relief-forming layer by means of heat and/or light to thus obtain a flexographic printing plate precursor having a crosslinked relief-forming layer, and an engraving step of laser-engraving the flexographic printing plate precursor having the crosslinked relief-forming layer, and more preferably comprises a layer formation step of forming a relief-forming layer from the resin composition for laser engraving of the present invention, a crosslinking step of crosslinking the relief-forming layer by means of heat to thus obtain a flexographic printing plate precursor having a crosslinked relief-forming layer, and an engraving step of laser-engraving the flexographic printing plate precursor having the crosslinked relief-forming layer.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for producing a flexographic printing plate of the present invention.

The flexographic printing plate of the present invention may suitably employ an aqueous ink when printing.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2, and especially preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The flexographic printing plate of the present invention has excellent rinsing properties, there is no engraved residue, and has excellent printing durability, and printing can be carried out for a long period of time without plastic deformation of the relief layer or degradation of printing durability.

In accordance with the present invention, there can be provided a resin composition for laser engraving that has excellent stability and can give a flexographic printing plate having excellent rinsing properties, ink transfer properties, and printing durability, a flexographic printing plate precursor and a process for producing same employing the resin composition for laser engraving, and a flexographic printing plate and a process for making same.

### EXAMPLES

The present invention is explained in further detail below by reference to Examples, but the present invention should not be construed as being limited to these Examples. Furthermore, ‘parts’ in the description below means ‘parts by weight’, and ‘%’ means ‘% by weight’, unless otherwise specified.

Moreover, the number-average molecular weight (Mn) of a polymer in the Examples are values measured by a GPC method unless otherwise specified.

### <Measurement of Number-Average Molecular Weight (Mn) of Resin>

The number-average molecular weight of a resin was determined using gel permeation chromatography (GPC) on the basis of a polystyrene of known molecular weight. Measurement was carried out using a high performance GPC system (HLC-8020, Tosoh Corporation) and a polystyrene-packed column (TSKgel GMHXL, Tosoh Corporation) while developing with tetrahydrofuran (THF). The temperature of the column was set at 40° C. As the sample that was injected into the GPC system, a THF solution having a resin concentration of 1 wt % was prepared, and the amount injected was 10 μL. Furthermore, as a detector, a resin UV absorption detector was used, and as a monitoring light, light at 254 nm was used.

### <Measurement of Number of Ethylenically Unsaturated Groups in Resin>

The average number of ethylenically unsaturated groups present in the resin molecule was determined by removing unreacted low molecular weight components using liquid chromatography and then carrying out molecular structure analysis using nuclear magnetic resonance spectroscopy (NMR, AVANCE600, Bruker BioSpin). The number of ethylenically unsaturated groups in a resin means the average number of ethylenically unsaturated groups present per a resin molecule.

The synthesis of plastomers is now explained below.

### <Synthesis of Resin (A1)-1>

A separable flask equipped with a thermometer, a stirrer, and a condenser was charged with 1,318 parts of ‘PCDL T4672’™ (number-average molecular weight 2,059, OH value 54.5), which is a polycarbonate diol manufactured by Asahi Kasei Corporation, 168.8 g parts of (b1)-1 below, 1.5 parts of 4-hydroxy-TEMPO (4-hydroxy-2,2,6,6-tetramethylpiperidine 1-oxyl free radical, Tokyo Chemical Industry Co., Ltd.), and 3 parts of DBU (1,8-diazabicyclo[5.4.0]-7-undecene, Tokyo Chemical Industry Co., Ltd.), and a reaction was carried out at normal pressure (1 atm, the same applies below) and 80° C. for about 3 hours while removing by distillation the methanol that was formed. This gave resin (A1)-1 containing terminal methacrylic groups (about 1.9 per molecule on average of ethylenically unsaturated groups in the molecule) and having a number-average molecular weight of about 2,500. This resin was a liquid at room temperature (20° C., the same applies below), flowed when an external force was applied, and did not recover to the original shape even when the external force was removed. Tg of this resin is less than 20° C.

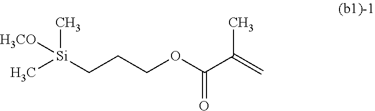

### <Synthesis of Resin (A1)-2>

A separable flask equipped with a thermometer, a stirrer, and a condenser was charged with 1,318 parts of ‘PCDL T4672’™ (number-average molecular weight 2,059, OH value 54.5), which is a polycarbonate diol manufactured by Asahi Kasei Corporation, and 76.8 parts of tolylene diisocyanate, and a reaction was carried out while heating at 80° C. for about 3 hours; subsequently 73.4 parts of (b1)-1 above, 1.5 parts of 4-hydroxy-TEMPO (4-hydroxy-2,2,6,6-tetramethylpiperidine 1-oxyl free radical, Tokyo Chemical Industry Co., Ltd.), and 3 parts of DBU (1,8-diazabicyclo[5.4.0]-7-undecene, Tokyo Chemical Industry Co., Ltd.) were added, and a reaction was carried out at normal pressure (1 atm, the same applies below) and 80° C. for about 3 hours while removing by distillation the methanol that was formed. This gave resin (A1)-2 containing terminal methacrylic groups (about 1.8 per molecule on average of ethylenically unsaturated groups in the molecule) and having a number-average molecular weight of about 8,000. This resin was a liquid at room temperature, flowed when an external force was applied, and did not recover to the original shape even when the external force was removed. Tg of this resin is less than 20° C.

### <Synthesis of Resin (A1)-3>

A separable flask equipped with a thermometer, a stirrer, and a condenser was charged with 500 parts of ‘Poly bd R-45HT’™ (number-average molecular weight 2,800, OH value 46.6), which is a terminal hydroxy group polybutadiene polyol manufactured by Idemitsu Kosan Co., Ltd., 89.8 parts of (b1)-1 above, 1.8 parts of 4-hydroxy-TEMPO (4-hydroxy-2,2,6,6-tetramethylpiperidine 1-oxyl free radical, Tokyo Chemical Industry Co., Ltd.), and 3.7 parts of DBU (1,8-diazabicyclo[5.4.0]-7-undecene, Tokyo Chemical Industry Co., Ltd.), and a reaction was carried out at normal pressure and 80° C. for about 3 hours while removing by distillation the methanol that was formed. This gave resin (A1)-3 containing terminal methacrylic groups (about 1.9 per molecule on average of ethylenically unsaturated groups in the molecule) and having a number-average molecular weight of 3,100. This resin was a liquid at room temperature, flowed when an external force was applied, and did not recover to the original shape even when the external force was removed. Tg of this resin is less than 20° C.

### <Synthesis of Resin (A1)-4>

A separable flask equipped with a thermometer, a stirrer, and a condenser was charged with 500 parts of ‘Poly bd R-45HT’™ (number-average molecular weight 2,800, OH value 46.6), which is a terminal hydroxy group polybutadiene polyol manufactured by Idemitsu Kosan Co., Ltd., 84.0 parts of (b1)-2 below, 1.8 parts of 4-hydroxy-TEMPO (4-hydroxy-2,2,6,6-tetramethylpiperidine 1-oxyl free radical, Tokyo Chemical Industry Co., Ltd.), and 3.7 parts of DBU (1,8-diazabicyclo[5.4.0]-7-undecene, Tokyo Chemical Industry Co., Ltd.), and a reaction was carried out at normal pressure and 65° C. for about 5 hours while removing by distillation the methanol that was formed. This gave resin (A1)-4 containing terminal methacrylic groups (about 1.6 per molecule on average of ethylenically unsaturated groups in the molecule) and having a number-average molecular weight of 3,200. This resin was a liquid at room temperature, flowed when an external force was applied, and did not recover to the original shape even when the external force was removed. Tg of this resin is less than 20° C.

### <Synthesis of Resin (A1)-5>

A separable flask equipped with a thermometer, a stirrer, and a condenser was charged with 500 parts of ‘Poly bd R-45HT’™ (number-average molecular weight 2,800, OH value 46.6), which is a terminal hydroxy group polybutadiene polyol manufactured by Idemitsu Kosan Co., Ltd., 96.5 parts of (b1)-3 below, 1.8 parts of 4-hydroxy-TEMPO (4-hydroxy-2,2,6,6-tetramethylpiperidine 1-oxyl free radical, Tokyo Chemical Industry Co., Ltd.), and 3.7 parts of DBU (1,8-diazabicyclo[5.4.0]-7-undecene, Tokyo Chemical Industry Co., Ltd.), and a reaction was carried out at normal pressure and 70° C. for about 2 hours while removing by distillation the methanol that was formed. This gave resin (A1)-5 containing terminal methacrylic groups (about 1.6 per molecule on average of ethylenically unsaturated groups in the molecule) and having a number-average molecular weight of 3,200. This resin was a liquid at room temperature, flowed when an external force was applied, and did not recover to the original shape even when the external force was removed. Tg of this resin is less than 20° C.

### <Synthesis of Resin (A1)-6>

A separable flask equipped with a thermometer, a stirrer, and a condenser was charged with 500 parts of ‘Poly bd R-45HT’™ (number-average molecular weight 2,800, OH value 46.6), which is a terminal hydroxy group polybutadiene polyol manufactured by Idemitsu Kosan Co., Ltd., 103.1 parts of (b1)-4 below, 1.8 parts of 4-hydroxy-TEMPO (4-hydroxy-2,2,6,6-tetramethylpiperidine 1-oxyl free radical, Tokyo Chemical Industry Co., Ltd.), and 3.7 parts of DBU (1,8-diazabicyclo[5.4.0]-7-undecene, Tokyo Chemical Industry Co., Ltd.), and a reaction was carried out at normal pressure and 70° C. for about 2 hours while removing by distillation the methanol that was formed. This gave resin (A1)-6 containing terminal methacrylic groups (about 1.6 per molecule on average of ethylenically unsaturated groups in the molecule) and having a number-average molecular weight of 3,250. This resin was a liquid at room temperature, flowed when an external force was applied, and did not recover to the original shape even when the external force was removed. Tg of this resin is less than 20° C.

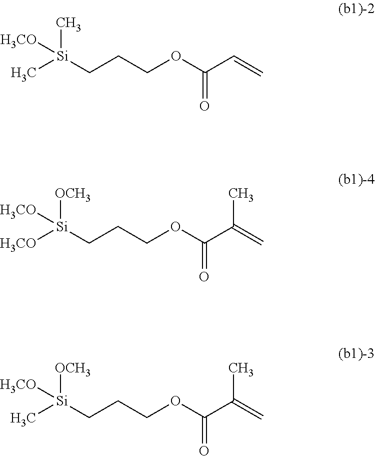

### <Synthesis of Resin (A2)-1>

A separable flask equipped with a thermometer, a stirrer, and a condenser was charged with 1,000 parts of ‘KF-9701’™ (number-average molecular weight 3,000, Si equivalent 1,500 g/mol), which is a straight-chain organopolysiloxane compound manufactured by Shin-Etsu Chemical Co., Ltd., 86.8 parts of 2-hydroxyethyl methacrylate (Tokyo Chemical Industry Co., Ltd.), 1.1 parts of 4-hydroxy-TEMPO (4-hydroxy-2,2,6,6-tetramethylpiperidine 1-oxyl free radical, Tokyo Chemical Industry Co., Ltd.), and 3.3 parts of DBU (1,8-diazabicyclo[5.4.0]-7-undecene, Tokyo Chemical Industry Co., Ltd.), and a reaction was carried out at normal pressure and 80° C. for about 3 hours while removing by distillation the water that was formed. This gave resin (A2)-1 containing terminal methacrylic groups (about 1.7 per molecule on average of ethylenically unsaturated groups in the molecule) and having a number-average molecular weight of 4,500. This resin was a liquid at room temperature, flowed when an external force was applied, and did not recover to the original shape even when the external force was removed. Tg of this resin is less than 20° C.

### <Synthesis of Resin (A2)-2>

A separable flask equipped with a thermometer, a stirrer, and a condenser was charged with 500 parts of ‘Poly bd R-45HT’™ (number-average molecular weight 2,800, OH value 46.6), which is a terminal hydroxy group polybutadiene polyol manufactured by Idemitsu Kosan Co., Ltd., 71.9 parts of 3-isocyanatopropyldimethylmethoxysilane, and 3 parts of DBU (1,8-diazabicyclo[5.4.0]-7-undecene, Tokyo Chemical Industry Co., Ltd.), and a reaction was carried out at normal pressure and 50° C. for about 3 hours; subsequently 1.8 parts of 4-hydroxy-TEMPO (4-hydroxy-2,2,6,6-tetramethylpiperidine 1-oxyl free radical, Tokyo Chemical Industry Co., Ltd.) and 54.1 parts of 2-hydroxyethyl methacrylate (Tokyo Chemical Industry Co., Ltd.) were added, and a reaction was carried out at normal pressure and 80° C. for about 3 hours while removing by distillation the methanol that was formed. This gave resin (A2)-2 containing terminal methacrylic groups (about 1.8 per molecule on average of ethylenically unsaturated groups in the molecule) and having a number-average molecular weight of 3,500. This resin was a liquid at room temperature, flowed when an external force was applied, and did not recover to the original shape even when the external force was removed. Tg of this resin is less than 20° C.

### <Synthesis of Resin (A3)-1>

A separable flask equipped with a thermometer, a stirrer, and a condenser was charged with 500 parts of ‘KF-9701’™ (number-average molecular weight 3,000, Si equivalent 1,500 g/mol), which is a straight-chain organopolysiloxane compound manufactured by Shin-Etsu Chemical Co., Ltd., 72.0 parts of (b1)-1 above, 1.8 parts of 4-hydroxy-TEMPO (4-hydroxy-2,2,6,6-tetramethylpiperidine 1-oxyl free radical, Tokyo Chemical Industry Co., Ltd.), and 3 parts of DBU (1,8-diazabicyclo[5.4.0]-7-undecene, Tokyo Chemical Industry Co., Ltd.), and a reaction was carried out at normal pressure and 80° C. for about 3 hours while removing by distillation the water that was formed. This gave resin (A3)-1 containing terminal methacrylic groups (about 1.9 per molecule on average of ethylenically unsaturated groups in the molecule) and having a number-average molecular weight of about 5,000. This resin was a liquid at room temperature, flowed when an external force was applied, and did not recover to the original shape even when the external force was removed. Tg of this resin is less than 20° C.

### <Synthesis of Resin (A3)-2>

A separable flask equipped with a thermometer, a stirrer, and a condenser was charged with 500 parts of ‘Poly bd R-45HT’™ (number-average molecular weight 2,800, OH value 46.6), which is a terminal hydroxy group polybutadiene polyol manufactured by Idemitsu Kosan Co., Ltd., 71.9 parts of 3-isocyanatopropyldimethylmethoxysilane, 3 parts of DBU (1,8-diazabicyclo[5.4.0]-7-undecene, Tokyo Chemical Industry Co., Ltd.), and 7.4 parts of distilled water, and a reaction was carried out at normal pressure and 60° C. for about 3 hours; subsequently 1.8 parts of 4-hydroxy-TEMPO (4-hydroxy-2,2,6,6-tetramethylpiperidine 1-oxyl free radical, Tokyo Chemical Industry Co., Ltd.) and 89.9 parts of (b1)-1 above were added, and a reaction was carried out at normal pressure and 80° C. for about 3 hours while removing by distillation the water and methanol that were formed. This gave resin (A3)-2 containing terminal methacrylic groups (about 1.8 per molecule on average of ethylenically unsaturated groups in the molecule) and having a number-average molecular weight of 4,500. This resin was a liquid at room temperature, flowed when an external force was applied, and did not recover to the original shape even when the external force was removed. Tg of this resin is less than 20° C.

### <Preparation of Comparative Polymer (CP)-1>

A separable flask equipped with a thermometer, a stirrer, and a condenser was charged with 1,318 parts of ‘PCDL T4672’™ (number-average molecular weight 2,059, OH value 54.5), which is a polycarbonate diol manufactured by Asahi Kasei Corporation, and 76.8 parts of tolylene diisocyanate, and a reaction was carried out while heating at 80° C. for about 3 hours; subsequently 52.6 parts of 2-methacryloyloxyethyl isocyanate was added, and a reaction was carried out for about a further 3 hours, thus giving resin (CP)-1 having terminal methacrylic groups (about 1.7 per molecule on average of ethylenically unsaturated groups in the molecule) and having a number-average molecular weight of about 7,000. This resin was a syrup at 20° C., flowed when an external force was applied, and did not recover to the original shape even when the external force was removed. Tg of this resin is less than 20° C.

### <Preparation of Comparative Polymer (CP)-2>

A separable flask equipped with a thermometer, a stirrer, and a condenser was charged with 413.72 parts of ‘KF-6003’ (number-average molecular weight 5,100, OH value 22.0), which is a both termini carbinol-modified reactive silicone oil manufactured by Shin-Etsu Chemical Co., Ltd., and 11.05 parts of tolylene diisocyanate, and a reaction was carried out while heating at 80° C. for about 3 hours; subsequently 4.99 parts of 2-acryloyloxyethyl isocyanate was added, and a reaction was carried out for about a further 3 hours, thus giving resin (CP)-2 having terminal acrylic groups (about 1.8 per molecule on average of ethylenically unsaturated groups in the molecule) and having a number-average molecular weight of about 20,000. This resin was a syrup at 20° C., flowed when an external force was applied, and did not recover to the original shape even when the external force was removed. Tg of this resin is less than 20° C.

Details of Component A used in the Examples below are as follows.

Acrylic resin 1: cyclohexyl methacrylate/2-hydroxyethyl methacrylate 70/30 (mole %) copolymer, Mn=15,000)
Acrylic resin 2: cyclohexyl methacrylate/allyl methacrylate 70/30 (mole %) copolymer, Mn=20,000)
S-LEC BM-2: polyvinyl butyral, Tg 67° C., Sekisui Chemical Co., Ltd.
TR2000: styrene/butadiene block copolymer, thermoplastic elastomer, manufactured by JSR

All of acrylic resin 1, acrylic resin 2, and S-LEC BM-2 were solids at 20° C.

### Example 1

### 1. Preparation of Resin Composition for Laser Engraving

A three-necked flask equipped with a stirring blade and a condenser was charged with 50 parts of (A1)-1 as Component A and, as a solvent, 47 parts of propylene glycol monomethyl ether acetate, and heated at 70° C. for 120 minutes while stirring to thus dissolve the polymer. Subsequently, the solution was set at 40° C., 25 parts of Blemmer PDE-200 (polyethylene glycol dimethacrylate (number of repeats of ethylene glycol structure: about 4), NOF Corporation) and 10 parts of triethylene glycol dimethacrylate (TEGDMA) (Tokyo Chemical Industry Co., Ltd.) as ethylenically unsaturated compounds, 0.5 parts of t-butylperoxybenzoate (product name: Perbutyl Z, NOF Corporation) as a polymerization initiator, and 1 part of Ketjen Black EC600JD (carbon black, Lion Corporation) as a photothermal conversion agent were further added, and stirring was carried out for 30 minutes. As a result of the above operations, flowable coating solution 1 for a crosslinkable relief-forming layer (resin composition 1 for laser engraving) was obtained.

### 2. Preparation of Flexographic Printing Plate Precursor for Laser Engraving

A spacer (frame) having a predetermined thickness was placed on a PET substrate, and coating solution 1 for a crosslinkable relief-forming layer obtained above was cast gently so that it did not overflow from the spacer (frame) and dried in an oven at 70° C. for 3 hours. Subsequently, heating was carried out at 80° C. for 3 hours and at 100° C. for a further 3 hours to thus thermally crosslink the relief-forming layer to provide a relief-forming layer having a thickness of about 1 mm, thus preparing flexographic printing plate precursor 1 for laser engraving.

### 3. Making Flexographic Printing Plate

The relief-forming layer after crosslinking (crosslinked relief-forming layer) was engraved using the two types of laser below.

As a carbon dioxide laser engraving machine, for engraving by irradiation with a laser, an ML-9100 series high quality CO₂ laser marker (Keyence) was used. A 1 cm square solid printed part was raster-engraved using the carbon dioxide laser engraving machine under conditions of an output of 12 W, a head speed of 200 mm/sec, and a pitch setting of 2,400 DPI, thus forming halftone dots with a highlight of 1% to 10%.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed part was raster-engraved using the semiconductor laser engraving machine under conditions of a laser output of 7.5 W, a head speed of 409 mm/sec, and a pitch setting of 2,400 DPI, thus forming halftone dots with a highlight of 1% to 10%.

The thickness of the relief layer of the flexographic printing plate thus obtained was about 1 mm.

### Examples 2 to 10 and Comparative Examples 1 to 6

### 1. Preparation of Resin Composition for Laser Engraving

Coating solutions for a crosslinkable relief-forming layer (resin compositions for laser engraving) 2 to 10 and comparative coating solutions for a crosslinkable relief-forming layer (resin compositions for laser engraving) 1 to 6 were prepared in the same manner as for Example 1 except that resin (A1)-1 used in Example 1 was changed to those described in Table 1 below.

### 2. Preparation of Flexographic Printing Plate Precursor for Laser Engraving

Flexographic printing plate precursors 2 to 10 for laser engraving of Examples and flexographic printing plate precursors 1 to 6 for laser engraving of Comparative Examples were prepared in the same manner as in Example 1 except that coating solution 1 for a crosslinkable relief-forming layer in Example 1 was changed to coating solutions 2 to 10 for a crosslinkable relief-forming layer and comparative coating solutions 1 to 6 for a crosslinkable relief-forming layer.

### 3. Preparation of Flexographic Printing Plate

Flexographic printing plates 2 to 10 of Examples and flexographic printing plates 1 to 6 of Comparative Example were obtained by subjecting the relief-forming layers of flexographic printing plate precursors 2 to 10 for laser engraving of the Examples and flexographic printing plate precursors 1 to 6 for laser engraving of the Comparative Examples to thermal crosslinking and then engraving to form a relief layer as in Example 1.

The thickness of the relief layers of these flexographic printing plates was about 1 mm.

### Examples 11 to 13

### 1. Preparation of Crosslinkable Resin Composition for Laser Engraving

Coating solutions (resin compositions for laser engraving) 11 to 13 for a crosslinkable relief-forming layer were prepared in the same manner as in Example 3 except that the ethylenically unsaturated compound used in Example 3 was changed to those described in Table 1 below.

The PEGDA used in Example 13 was polyethylene glycol diacrylate (ALDRICH).

### 2. Preparation of Flexographic Printing Plate Precursor for Laser Engraving

Flexographic printing plate precursors 11 to 13 for laser engraving of Examples were obtained in the same manner as in Example 3 except that coating solution 3 for a crosslinkable relief-forming layer of Example 3 was changed to coating solutions 11 to 13 for a crosslinkable relief-forming layer.

### 3. Preparation of Flexographic Printing Plate

Flexographic printing plates 11 to 13 of Examples were obtained by subjecting flexographic printing plate precursors 11 to 13 for laser engraving of the Examples to thermal crosslinking and then engraving to form a relief layer as in Example 3.

The thickness of the relief layers of these flexographic printing plates was about 1 mm.

### 4. Evaluation of Flexographic Printing Plate

Evaluation of the performance of the flexographic printing plates was carried out in terms of the items below, and the results are shown in Table 1. The evaluation results when engraving was carried out using a carbon dioxide laser and the evaluation results when engraving was carried out using a semiconductor laser were the same.

### (4-1) Rinsing Properties

A laser-engraved flexographic printing plate was immersed in water and an engraved part was rubbed with a toothbrush (Clinica Toothbrush Flat, Lion Corporation) 10 times. Subsequently, the presence/absence of residue on the surface of the relief layer was checked by an optical microscope. When there was no residue, the evaluation was 1, when there was hardly any residue the evaluation was 2, when there was a little residue the evaluation was 3, when there was some residue remaining but there was no practical problem the evaluation was 4, and when the residue could not be removed and there was a practical problem the evaluation was 5.

### (4-2) Ink Transfer Properties

A flexographic printing plate that had been obtained was set in a printer (Model ITM-4, IYO KIKAI SEISAKUSHO Co., Ltd.), as the ink Aqua SPZ16 Red aqueous ink (Toyo Ink Manufacturing Co., Ltd.) was used without dilution, and printing was carried out continuously using Full Color Form M 70 (Nippon Paper Industries Co., Ltd., thickness 100 μm) as the printing paper, and the degree of ink attachment in a solid printed part on the printed material at 1,000 m from the start of printing was compared by visual inspection.

With regard to evaluation criteria, one that was uniform without unevenness in density was evaluated as 1, one with unevenness was evaluated as 3, and a degree midway between 1 and 3 was evaluated as 2.

### (4-3) Coating Solution Stability

Evaluated by heating a coating solution (resin composition for laser engraving) at 70° C. for 1 hour and visually examining the flowability of the coating solution as change in viscosity between that before and that after heating. When an increase in viscosity could not be observed by eye it was evaluated as 1, when an increase in viscosity could be observed by eye it was evaluated as 2, and when it almost stopped flowing or became a gel it was evaluated as 3.

### (4-4) Printing Durability

A flexographic printing plate that had been obtained was set in a printer (Model ITM-4, IYO KIKAI SEISAKUSHO Co., Ltd.), as the ink Aqua SPZ16 Red aqueous ink (Toyo Ink Manufacturing Co., Ltd.) was used without dilution, and printing was carried out continuously using Full Color Form M 70 (Nippon Paper Industries Co., Ltd., thickness 100 μm) as the printing paper, and a highlight of 1% to 10% was confirmed for a printed material. The end of printing was defined when there was a halftone dot that was not printed, and the length (meters) of paper that was printed up to the end of printing was used as an index. The larger the value, the better the printing durability.

TABLE 1

| | | | | | | Coating | Printing |
|---|---|---|---|---|---|---|---|
| | | | | Rinsing | Ink transfer | solution | durability |
| | Component A | Component B | | properties | properties | stability | (m) |
| Ex. 1 | (A1)-1 | Blemmer | TEGDMA | 1 | 1 | 1 | 2,200 |
| | | PDE-200 | | | | | |
| Ex. 2 | (A1)-2 | Blemmer | TEGDMA | 1 | 1 | 2 | 1,900 |
| | | PDE-200 | | | | | |
| Ex. 3 | (A1)-3 | Blemmer | TEGDMA | 1 | 1 | 1 | 2,500 |
| | | PDE-200 | | | | | |
| Ex. 4 | (A2)-1 | Blemmer | TEGDMA | 1 | 2 | 1 | 1,600 |
| | | PDE-200 | | | | | |
| Ex. 5 | (A2)-2 | Blemmer | TEGDMA | 1 | 1 | 2 | 1,900 |
| | | PDE-200 | | | | | |
| Ex. 6 | (A3)-1 | Blemmer | TEGDMA | 1 | 2 | 1 | 1,400 |
| | | PDE-200 | | | | | |
| Ex. 7 | (A3)-2 | Blemmer | TEGDMA | 1 | 1 | 2 | 1,700 |
| | | PDE-200 | | | | | |
| Ex. 8 | (A1)-4 | Blemmer | TEGDMA | 1 | 1 | 2 | 2,200 |
| | | PDE-200 | | | | | |
| Ex. 9 | (A1)-5 | Blemmer | TEGDMA | 1 | 1 | 2 | 1,900 |
| | | PDE-200 | | | | | |
| Ex. 10 | (A1)-6 | Blemmer | TEGDMA | 1 | 2 | 2 | 1,700 |
| | | PDE-200 | | | | | |
| Ex. 11 | (A1)-3 | — | TEGDMA | 1 | 2 | 1 | 2,400 |
| Ex. 12 | (A1)-3 | Blemmer | — | 1 | 1 | 1 | 1,700 |
| | | PDE-200 | | | | | |
| Ex. 13 | (A1)-3 | — | PEGDA | 1 | 1 | 1 | 2,000 |
| | | | (Mn ≈ 750) | | | | |
| Comp. | (CP)-1 | Blemmer | TEGDMA | 5 | 2 | 3 | 1,300 |
| Ex. 1 | | PDE-200 | | | | | |
| Comp. | (CP)-2 | Blemmer | TEGDMA | 1 | 3 | 3 | 1,400 |
| Ex. 2 | | PDE-200 | | | | | |
| Comp. | Acrylic | Blemmer | TEGDMA | 5 | 3 | 1 | 500 |
| Ex. 3 | resin 1 | PDE-200 | | | | | |
| Comp. | Acrylic | Blemmer | TEGDMA | 5 | 3 | 3 | 1,000 |
| Ex. 4 | resin 2 | PDE-200 | | | | | |
| Comp. | S-LEC | Blemmer | TEGDMA | 4 | 3 | 1 | 1,500 |
| Ex. 5 | BM-2 | PDE-200 | | | | | |
| Comp. | TR2000 | Blemmer | TEGDMA | 5 | 2 | 1 | 1,300 |
| Ex. 6 | | PDE-200 | | | | | |

What is claimed is:

1. A resin composition for laser engraving comprising:
(Component A) a resin that has a group selected from the group consisting of groups represented by Formula (I) to Formula (III) and is a plastomer at 20° C.;
(Component B) an ethylenically unsaturated compound; and
(Component C) a polymerization initiator, 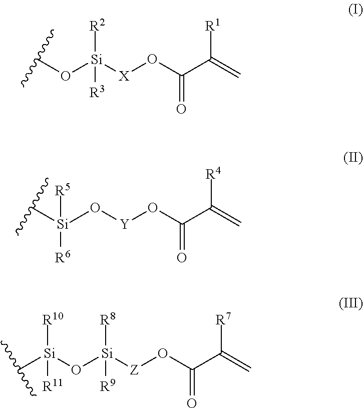
wherein in Formula (I) to Formula (III) X, Y, and Z independently denote an alkylene group having 1 to 30 carbons, R¹, R⁴, and R⁷ independently denote a hydrogen atom or a methyl group, R², R³, R⁵, R⁶, R⁸, R⁹, R¹⁰, and R¹¹ independently denote an alkyl group, an alkoxy group, a halogen atom, or a hydroxy group, and a wavy line portion denotes a position of bonding to another structure.

2. The resin composition for laser engraving according to claim 1, wherein R², R³, R⁵, R⁶, R⁸, and R⁹ above are independently alkyl groups.

3. The resin composition for laser engraving according to claim 1, wherein Component A is a resin that has a group represented by Formula (I) or Formula (II) and is a plastomer at 20° C.

4. The resin composition for laser engraving according to claim 1, wherein Component A is a resin that has a group represented by Formula (I) and is a plastomer at 20° C.

5. The resin composition for laser engraving according to claim 1, wherein Component A is a resin that has on at least a main chain terminal a group selected from the group consisting of groups represented by Formula (I) to Formula (III).

6. The resin composition for laser engraving according to claim 3, wherein R², R³, R⁵, and R⁶ above are independently alkyl groups.

7. The resin composition for laser engraving according to claim 3, wherein R² and R³ above are independently alkyl groups.

8. The resin composition for laser engraving according to claim 5, wherein Component A is a resin that has on at least a main chain terminal a group selected from the group consisting of groups represented by Formula (I) or Formula (II).

9. The resin composition for laser engraving according to claim 5, wherein Component A is a resin that has on at least a main chain terminal a group selected from the group consisting of groups represented by Formula (I).

10. The resin composition for laser engraving according to claim 1, wherein Component A is a straight-chain resin.

11. The resin composition for laser engraving according to claim 1, wherein Component B comprises a polyalkylene glycol di(meth)acrylate.

12. The resin composition for laser engraving according to claim 1, wherein Component B comprises at least two types of polyalkylene glycol di(meth)acrylates.

13. The resin composition for laser engraving according to claim 1, wherein the resin composition further comprises (Component D) a photothermal conversion agent.

14. A flexographic printing plate precursor for laser engraving, comprising a relief-forming layer comprising the resin composition for laser engraving according to claim 1.

15. A flexographic printing plate precursor for laser engraving, comprising a crosslinked relief-forming layer formed by crosslinking by means of light and/or heat a relief-forming layer comprising the resin composition for laser engraving according to claim 1.

16. A process for producing a flexographic printing plate precursor for laser engraving, comprising:
a layer formation step of forming a relief-forming layer comprising the resin composition for laser engraving according to claim 1; and
a crosslinking step of crosslinking the relief-forming layer by means of light and/or heat to thus obtain a flexographic printing plate precursor comprising a crosslinked relief-forming layer.

17. The process for producing a flexographic printing plate precursor for laser engraving according to claim 16, wherein the crosslinking step is a step of crosslinking the relief-forming layer by means of heat to thus obtain a flexographic printing plate precursor comprising a crosslinked relief-forming layer.

18. A process for making a flexographic printing plate, comprising:
an engraving step of laser-engraving the crosslinked relief-forming layer made by the process for producing a flexographic printing plate precursor for laser engraving according to claim 16.

19. A flexographic printing plate comprising a relief layer made by the process for making a flexographic printing plate according to claim 18.
